(19) United States
(12) Patent Application Publication
(10) Pub. No.: US 2025/0106887 A1
(43) Pub. Date: Mar. 27, 2025

(54) APPARATUS AND METHOD FOR DELAYING WAKE-UP OF A MAIN RADIO

(71) Applicant: Lenovo (Singapore) Pte. Ltd., Singapore (SG)

(72) Inventors: Shwetha Sreejith, Hessen (DE); Joachim Löhr, Wiesbaden (DE); Prateek Basu Mallick, Dreieich (DE); Karthikeyan Ganesan, Kronberg im Taunus (DE)

(21) Appl. No.: 18/896,330

(22) Filed: Sep. 25, 2024

Related U.S. Application Data
(60) Provisional application No. 63/585,283, filed on Sep. 26, 2023.

(51) Int. Cl. H04W 72/566; H04W 28/02; H04W 52/02; H04W 72/1268

(52) U.S. Cl. CPC H04W 72/566; H04W 28/0278; H04W 52/0235; H04W 72/1268

(57) ABSTRACT

Various aspects of the present disclosure relate to: receiving uplink data in a buffer of the UE; determining a priority of the uplink data, or an urgency of the uplink data, or both; and, in response to determining the priority of the uplink data, or the urgency of the uplink data, or both, delaying a wake-up of a main radio of the UE based at least in part on the priority of the uplink data in the buffer, or the urgency of the uplink data in the buffer, or both.

### TECHNICAL FIELD

The present disclosure relates to wireless communications, and more specifically to delaying wake-up of a main radio (MR).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may be used to: receive uplink data in a buffer of the UE; determine a priority of the uplink data, or an urgency of the uplink data, or both; and in response to determining the priority of the uplink data, or the urgency of the uplink data, or both, delay a wake-up of a main radio of the UE based at least in part on the priority of the uplink data in the buffer, or the urgency of the uplink data in the buffer, or both.

### BRIEF DESCRIPTION OF THE DRAWINGS

FIG. 1 illustrates an example of a wireless communications system in accordance with aspects of the present disclosure.

FIG. 2 illustrates an example of a user equipment (UE) in accordance with aspects of the present disclosure.

FIG. 3 illustrates an example of a processor in accordance with aspects of the present disclosure.

FIG. 4 illustrates an example of a network equipment (NE) in accordance with aspects of the present disclosure.

FIG. 5 illustrates a flowchart of a method performed by a UE in accordance with aspects of the present disclosure.

FIG. 6 illustrates a flowchart of a method performed by a NE in accordance with aspects of the present disclosure.

### DETAILED DESCRIPTION

Certain configurations may be for low-power wake-up signal (WUS)/wake-up radio (WUR) for power-sensitive, small form-factor devices including internet-of-things (IoT) devices (e.g., such as industrial sensors, controllers, and so forth) and wearables. There may also be other devices that use low power (e.g., extended reality (XR), smart glasses, smart phones, and so forth.

In some configurations, one main radio (MR) in the UE is responsible for attaining service from its serving radio network (e.g., gNB). With a low-power wake-up radio (LP-WUR), the UE may offload some of its MR functionalities (e.g., paging) to the LP-WUR (LR) to conserve power. This may be done by allowing the MR to be in a sleep mode when the UE is in coverage of the LP-WUR. The LP-WUR may use a newly designed low-power signal, also known as a low-power wake up signal (LP-WUS) giving it an advantage to low power consumption, but this may come at a cost of reduced coverage of the LP-WUR as compared to the coverage of the MR.

A secondary radio with a lower coverage may mean that there needs to be some clear entry and exit conditions for use of a LP-WUR (LR) in UEs that are capable of this. An MR may be woken up when some UL data enters its buffer and a LP-WUS may no longer be monitored by the LR (e.g., until activated again by some means at a later instance of time). The problem here may be that when UL data enters the UE's buffer, the MR is woken up frequently, even when the data is a small amount data or has low priority and/or urgency. As such, the power saving gain of using the LR may be reduced. To combat this, some enhancements may be made to prevent the frequent wake-up of MR when UL data enters its buffer.

Found herein are some enhancements that may be done to the wake-up behavior of an MR (e.g., in RRC_CONNECTED Mode) for UEs that support the low-power wake-up radio. The enhancements may focus on different wake-up behavior of the MR for urgent and/or high-priority vs non-urgent and/or low priority data, and how this prioritization may be differentiated.

Certain configurations include an immediate wake-up of MR when any UL data enters its MAC buffer. This may facilitate that any UL data that enters its buffer when the MR is asleep will be transmitted as soon as the MR wakes up and receives an UL grant from the network after transmitting a buffer status report (BSR) or scheduling request (SR) for the data in its buffer as per legacy behavior.

Advantages of certain configurations herein may be as follows: timely transmission of UL data due to immediate wake-up of MR. Disadvantages of certain configurations may be as follows: 1) frequent wake-up of MR even when the data in its buffer may be of small amount or of low priority and/or urgency; 2) reduced power saving gain due to frequent wake-up of the MR; and/or 3) lesser usage of LP-WUS leading to redundancy of a secondary radio. The disadvantages with certain configurations may outweigh the advantages, and the embodiments herein may overcome these disadvantages by allowing for timely transmission based on the data priority and/or urgency without a severe compromise on the power saving gain.

Aspects of the present disclosure are described in the context of a wireless communications system.

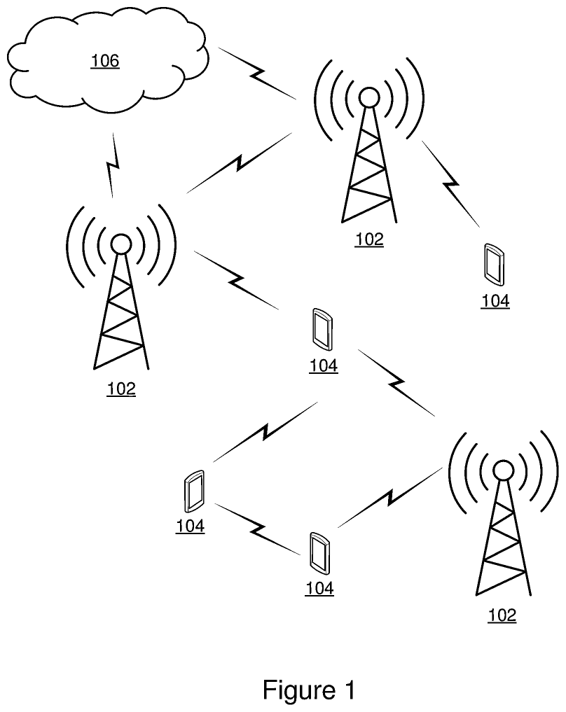

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. In some implementations, the first numerology (e.g., p=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., p=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In a first embodiment, there may be different MR Wake-Up behavior. In this embodiment, the MR may be woken up from its sleep state (e.g., light, micro, and/or deep sleep) according to a priority and/or urgency of the UL data arriving at the MR buffer and/or according to the UL data.

The MR may be immediately woken up (e.g., time taken for wake-up depends on the type of sleep of MR) when the UL data that enters the MR buffer is high priority and/or urgent data (e.g., RRC message) or a MAC CE. When this high priority and/or urgent data or MAC CE needs to be transmitted by the UE, the MR wakes up and triggers a BSR and subsequently a SR (if required) immediately (e.g., provided that a triggering condition for BSR/SR are met) as per certain behavior. Furthermore, when this data enters the UE's MAC buffer, the LR may stop monitoring for the LP-WUS signal.

Similarly, when some low priority and/or non-urgent data enters the UE buffer, the MR wake-up may be delayed based on a threshold (e.g., either a priority threshold or a data size threshold as described herein), so that the power saving gain of the LR is not severely compromised, and that the data may still be transmitted in a timely manner.

In one implementation, the MR wake-up may be delayed by delaying the triggering of the BSR. This can be achieved by configuring a new timer to trigger. This timer is started upon the entry of some low priority and/or non-urgent data (based on the priority threshold or logical channel priority as described herein) in the MAC buffer of the UE, provided that this UL data entry requires a MR wake-up and lead to a LP-WUS deactivation. Upon expiration of this timer, the BSR may be triggered and subsequently there may be a SR, if required. The value of this timer may be based on a PDB/PSDB of the data, the PDCP discard timer value, and/or the sleep state and wake-up time of MR. This timer may be configured by transmission from the network to the UE by RRC signaling (e.g., during RRC Connection Establishment or RRC Reconfiguration) and the timer may be running in either the LR or the MR.

In another implementation, the MR wake-up may be delayed by delaying the transmission of the BSR (and possibly a SR) that gets triggered after the entry of some low priority and/or non-urgent data (based on the priority threshold or logical channel priority as described herein) in the UE's buffer. A new timer to transmit may be configured by the network by RRC signaling (e.g., during RRC Connection Establishment or RRC Reconfiguration). The timer may be started when a BSR and/or SR gets triggered due to the entry of some low-priority and/or non-urgent data (e.g., based on the priority threshold or logical channel priority as described herein) enters the UE's buffer, provided that this data entry requires a MR wake-up and lead to a LP-WUS deactivation. Upon expiration of this timer, the BSR and/or SR are transmitted as per certain behavior. The value of this timer may be based on the PDB/PSDB of the data, the PDCP discard timer value, and/or the sleep state and wake-up time of MR and the timer may be running in either the LR or the MR.

In a second embodiment, there may be a delay budget based priority. In this embodiment, the priority of the data may be classified by its PDB or PSDB (in case of a PDU set). That is, a PDU or PDU Set with a small PDB or PSDB may be considered high priority or urgent data, and a PDU or PDU set with a large PDB or PSDB may be considered low-priority or non-urgent data. A delay budget based threshold may be maintained by the UE such that if the PDB/PSDB of the data that entered the buffer is below this threshold or if the data is a MAC CE, the MR may need to be immediately woken up and a BSR/SR may be triggered. If the UL data that entered the buffer has a PDB/PSDB greater than this threshold, the MR need not be woken up until the remaining delay budget of this UL data does not reach this threshold. The value of the threshold may be either based on a sleep state and a wake-up time of the MR, or a power saving requirement where, for example, the UE may smartly decide to delay data transmission depending on its current battery life such that the MR wake-up may be delayed if the UE is low on battery life or the MR wake-up may be sooner if the UE battery life is sufficient, or may be based on the transmission time for unit amount of data where, for example, the threshold may be based on how long the data transmission would take given the link conditions and/or channel quality. The threshold may be configured by the UE itself (e.g., based on the MR wake-up time, the power saving requirement, or the data priority and/or urgency in the buffer), or it may be configured by transmission from the network to the UE by means of RRC signaling, e.g., during connection establishment (based on the link conditions or data transmission time).

In a third embodiment, there may be a LCH priority based priority. In this embodiment, the priority of the data may be classified by its logical channel priority. Here, a new priority threshold may be maintained such that for logical channels (LCHs) with a LCH priority below the configured priority threshold, the MR does not wake up immediately and for data of LCHs and/or MAC CEs for which the priority exceeds this threshold, the MR is woken up immediately. The threshold may be configured on a per UE basis and it may either be configured by the UE itself, or it may be configured by the network with a transmission to the UE by means of RRC signaling, e.g. during connection establishment. The value of the threshold may be based on LCH priority values or on an MR sleep state and wake-up time. The MR wake-up may be delayed either by delaying the triggering of BSR/SR, or by delaying the BSR/SR transmission as described in relation to the first embodiment.

In a fourth embodiment, there may be a LCH priority based MR Wake-Up. In this embodiment, the MR wake-up is based on a LCH priority where each priority has a different MR wake-up timer. The wake-up timer may be started when the first data packet of the corresponding LCH enters the UE buffer. Upon expiry of the corresponding wake-up timer, the MR is woken up and a BSR/SR may be triggered or transmitted as defined in the first embodiment. The wake-up timers may be configured on a per LCH basis and configured by the network by means of some RRC signaling, e.g., RRC Connection Establishment or RRC Reconfiguration. The timer value may be based on the LCH priority value and the wake-up time of the MR. The wake-up timer may have smaller values for high priority and/or urgent data and have larger values for low priority and/or non-urgent data. For example, the wake-up timer may be set to 0 for the data of the highest priority LCH or for MAC CEs so that the MR may immediately wake-up and trigger a BSR and/or SR when such data enters its buffer.

In a fifth embodiment, there may be a data size based threshold. It may be possible that a UE buffer is quickly filled with a large amount of non-urgent data, in which case the amount of data to be transmitted at the same time, after the MR is woken up, may be quite large. This may lead to untimely transmission of some of the data, especially if the gNB is unable to grant the UE with enough resources simultaneously. Hence, another data size based threshold may be maintained such that if the amount of data in the MR buffer exceeds this threshold, the MR is woken up and a BSR/SR is triggered (provided that a BSR/SR triggering condition is satisfied). The threshold may either be configured by the UE itself or it may be configured by the network to the UE by means of RRC signaling (e.g., during connection establishment). The value of the threshold may be based on a total buffer size of the UE.

In a sixth embodiment, there may be a combination of thresholds. In this embodiment, the MR may be configured with a combination of one or more of the following threshold types-delay budget based, priority based, and/or data size based thresholds. With such embodiments, the wake-up of MR may be precisely optimized to enable maximum power saving gain without compromising on a timely manner of data transmission.

In one case, if the UE is configured with both delay budget and data size based thresholds, the MR is woken up when either one of these thresholds are met. For example, if the UE is configured with a delay budget threshold of ‘x’ ms and a data size threshold of ‘y’ bytes, the MR is woken up either if the remaining delay of the PDU/PDU Set is <=x or if the size of the PDUs/PDU Sets in the UE buffer is >=y.

In a seventh embodiment, a BSR trigger may be based on an MR Wake-Up. In this embodiment, a new BSR trigger may be defined based on MR wake-up and LP-WUS deactivation. That is, if a regular BSR is not triggered by the arrival of UL data in the UE's buffer when the MR is asleep, a BSR must anyway be triggered due to MR wake-up. This may ensure that the data arriving in the UE's buffer when the MR is asleep will be given adequate resources for data transmission after the MR is woken up.

In one implementation of the seventh embodiment, the BSR trigger may be based on an MR wake-up due to the remaining delay of the data in the UE's buffer exceeding the delay budget based threshold as described in the second embodiment, such that the BSR report includes information about the data volumes that have exceeded the delay budget threshold.

In another implementation, the BSR trigger may be based on MR wake-up due to a data size threshold as defined in the fifth embodiment being exceeded. That is, if the wake-up of MR is caused by the data volume in the UE buffer exceeding this data size threshold, the BSR reports the total volume of data in the buffer.

In an eighth embodiment, there may be CG enhancements for LR capable UEs. A UE may be configured with CG resources. The IE ConfiguredGrantConfig may be used to configure uplink transmission without dynamic grant according to two possible schemes. The actual uplink grant may either be configured via RRC (e.g., type1) or provided via the PDCCH (e.g., addressed to CS-RNTI) (e.g., type2). Multiple configured grant configurations may be configured in one BWP of a serving cell. The multiple configured grant configurations may provide configurations for time-frequency resources to be repeated with a corresponding periodicity.

A UE that is LP-WUR capable may benefit from a configuration of CGs so that a UE need not wake-up frequently to monitor for dynamic grants. If the MR would be woken up at every CG resource opportunity, irrespective of data availability, priority, and/or importance, the power saving benefits of implementing LR may be undermined. Therefore, in one embodiment, a UE skips CG transmission unless the available data meets any of the transmission conditions described herein (e.g., priority threshold, remaining PDB, total buffer size, LCH setting, and so forth). For example, if the UE determines that only very low priority data or data with a long remaining delay budget is available for transmission, the MR need not be woken up. Not using an uplink grant may invoke network side action, e.g., leading it to believe that UE's UL transmissions are not robust enough and therefore it may induce uplink grant modifications such as a changed MCS and TBS. If a serving gNB knows that the UE is a LP-WUR capable UE (e.g., from UE capability information), the serving gNB need not consider unused CG resources. Alternatively, the serving gNB may share CG resources with multiple UEs (e.g., network implementation) to reduce a collision probability and resource waste.

In another implementation, a UE uses a first CG resource even if available data does not meet any transmission conditions described herein (e.g., data threshold, priority, or remaining delay) but includes information giving a gNB an idea of how many CG occasions would be skipped. As a side point, an may MR remain awake when a retransmission timer is running.

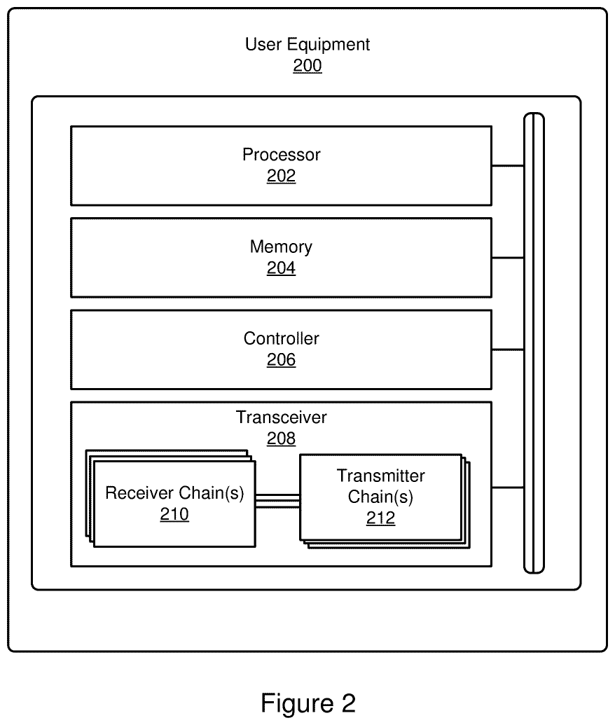

FIG. 2 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means to: receive uplink data in a buffer of the UE; determine a priority of the uplink data, or an urgency of the uplink data, or both; and in response to determining the priority of the uplink data, or the urgency of the uplink data, or both, delay a wake-up of a main radio of the UE based at least in part on the priority of the uplink data in the buffer, or the urgency of the uplink data in the buffer, or both.

The processor 202 may include an intelligent hardware device (e.g., a general-purpose processor, a DSP, a CPU, an ASIC, a field programmable gate array (FPGA), or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the UE 200 to perform one or more of the functions described herein (e.g., executing, by the processor 202, instructions stored in the memory 204). For example, the processor 202 may support wireless communication at the UE 200 in accordance with examples as disclosed herein.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 208. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

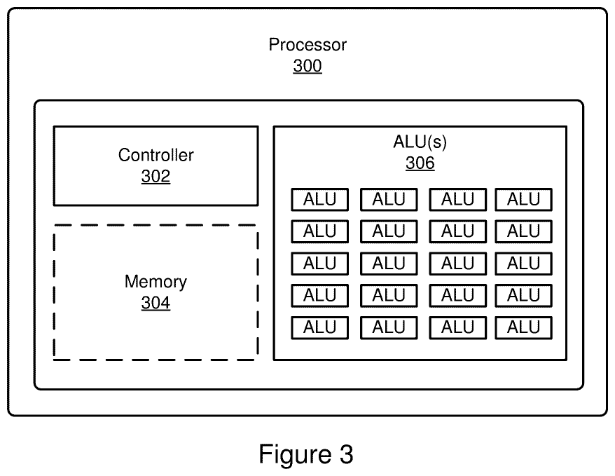

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein, such as to: receive uplink data in a buffer of the UE; determine a priority of the uplink data, or an urgency of the uplink data, or both; and in response to determining the priority of the uplink data, or the urgency of the uplink data, or both, delay a wake-up of a main radio of the UE based at least in part on the priority of the uplink data in the buffer, or the urgency of the uplink data in the buffer, or both. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

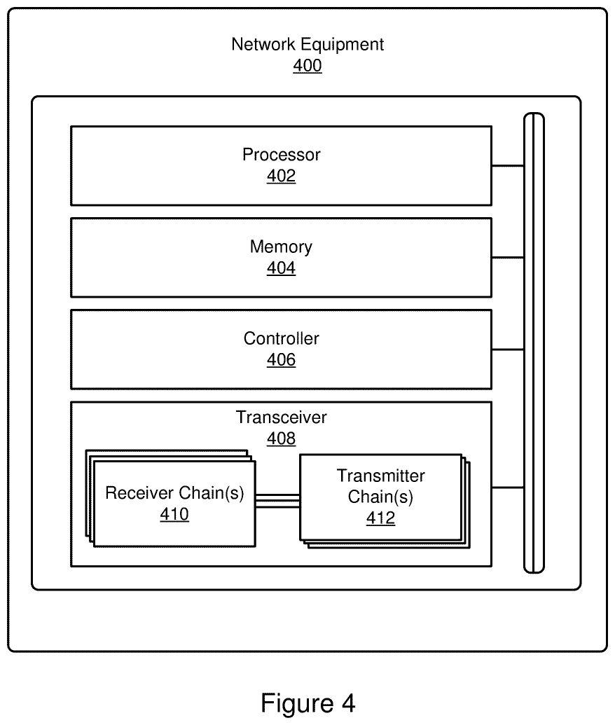

FIG. 4 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to: configure a threshold time to delay a wake up of a main radio of a user equipment (UE); and receive a buffer status report (BSR), or a scheduling request (SR), or both based on the threshold time to delay the wake up of the main radio.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

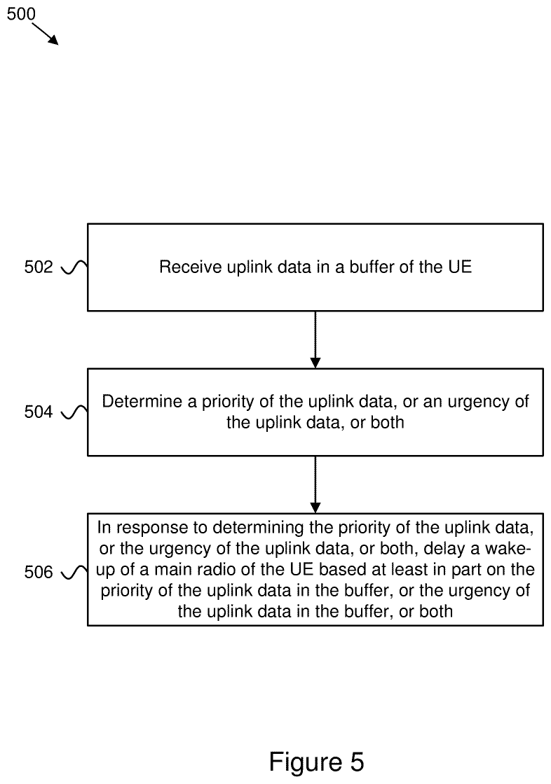

FIG. 5 illustrates a flowchart of a method 500 in accordance with aspects of the present disclosure. The operations of the method 500 may be implemented by a UE as described herein. In some implementations, the UE may execute a set of instructions to control the function elements of the UE to perform the described functions.

At 502, the method may include receiving uplink data in a buffer of the UE. The operations of 502 may be performed in accordance with examples as described herein. In some implementations, aspects of the operations of 502 may be performed by a UE as described with reference to FIG. 2.

At 504, the method may include determining a priority of the uplink data, or an urgency of the uplink data, or both. The operations of 504 may be performed in accordance with examples as described herein. In some implementations, aspects of the operations of 504 may be performed by a UE as described with reference to FIG. 2.

At 506, the method may include, in response to determining the priority of the uplink data, or the urgency of the uplink data, or both, delaying a wake-up of a main radio of the UE based at least in part on the priority of the uplink data in the buffer, or the urgency of the uplink data in the buffer, or both. The operations of 506 may be performed in accordance with examples as described herein. In some implementations, aspects of the operations of 506 may be performed a UE as described with reference to FIG. 2.

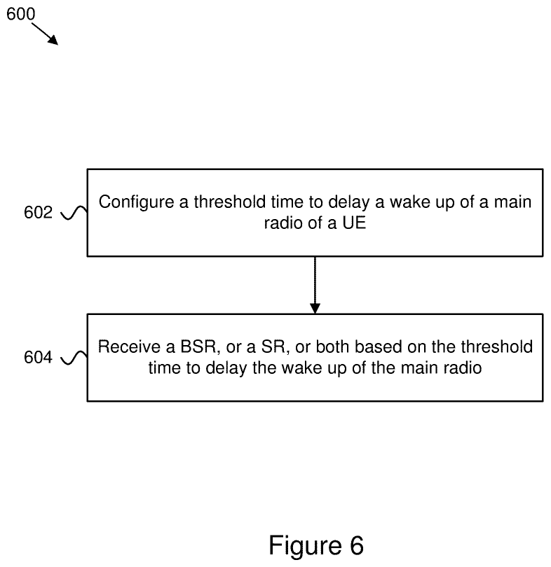

FIG. 6 illustrates a flowchart of a method 600 in accordance with aspects of the present disclosure. The operations of the method 600 may be implemented by a NE as described herein. In some implementations, the NE may execute a set of instructions to control the function elements of the NE to perform the described functions.

At 602, the method may include configuring a threshold time to delay a wake up of a main radio of a UE. The operations of 602 may be performed in accordance with examples as described herein. In some implementations, aspects of the operations of 602 may be performed by a NE as described with reference to FIG. 4.

At 604, the method may include receiving a BSR, or a SR, or both based on the threshold time to delay the wake up of the main radio. The operations of 604 may be performed in accordance with examples as described herein. In some implementations, aspects of the operations of 604 may be performed by a NE as described with reference to FIG. 4.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
receive uplink data in a buffer of the UE;
determine a priority of the uplink data, or an urgency of the uplink data, or both; and
in response to determining the priority of the uplink data, or the urgency of the uplink data, or both, delay a wake-up of a main radio of the UE based at least in part on the priority of the uplink data in the buffer, or the urgency of the uplink data in the buffer, or both.

2. The UE of claim 1, wherein the at least one processor is configured to cause the UE to delay the wake-up of the main radio of the UE until a threshold time after receiving the uplink data in the buffer.

3. The UE of claim 2, wherein the threshold time is based on a remaining delay, a data volume, logical channel priorities, or a combination thereof.

4. The UE of claim 2, wherein the threshold time is configured as a timer that triggers a buffer status report (BSR), or a scheduling request (SR), or both.

5. The UE of claim 4, wherein the at least one processor is configured to cause the UE to start the timer upon entry of low-priority uplink data in the buffer, or non-urgent uplink data in the buffer, or both.

6. The UE of claim 4, wherein the at least one processor is configured to cause the UE to trigger the BSR, or the SR, or both upon expiration of the timer.

7. The UE of claim 2, wherein the threshold time is configured as a timer to transmit a buffer status report (BSR), or a scheduling request (SR), or both.

8. The UE of claim 7, wherein the at least one processor is configured to cause the UE to start the timer upon triggering the BSR, or the SR, or both.

9. The UE of claim 7, wherein the at least one processor is configured to cause the UE to transmit the BSR, or the SR, or both upon expiration of the timer.

10. The UE of claim 1, wherein the priority of the uplink data comprises a logical channel (LCH) priority, and wherein a wake-up timer duration is based on the LCH priority.

11. The UE of claim 1, wherein the at least one processor is configured to cause the UE to, in response to the wake-up of the main radio, trigger a buffer status report (BSR).

12. The UE of claim 1, wherein the at least one processor is configured to cause the UE to skip one or more configured grant (CG) resources unless the uplink data meets requirements for the wake-up of the main radio.

13. A processor for wireless communication, comprising:
at least one controller coupled with at least one memory and configured to cause the processor to:
receive uplink data in a buffer;
determine a priority of the uplink data, or an urgency of the uplink data, or both; and
in response to determining the priority of the uplink data, or the urgency of the uplink data, or both, delay a wake-up of a main radio based at least in part on the priority of the uplink data in the buffer, or the urgency of the uplink data in the buffer, or both.

14. The processor of claim 13, wherein the at least one controller is configured to cause the processor to delay the wake-up of the main radio until a threshold time after receiving the uplink data in the buffer.

15. The processor of claim 14, wherein the threshold time is based on a remaining delay, a data volume, logical channel priorities, or a combination thereof.

16. The processor of claim 14, wherein the threshold time is configured as a timer that triggers a buffer status report (BSR), or a scheduling request (SR), or both.

17. The processor of claim 16, wherein the at least one controller is configured to cause the processor to start the timer upon entry of low-priority uplink data in the buffer, or non-urgent uplink data in the buffer, or both.

18. The processor of claim 16, wherein the at least one controller is configured to cause the processor to trigger the BSR, or the SR, or both upon expiration of the timer.

19. A method performed by a user equipment (UE), the method comprising:
receiving uplink data in a buffer of the UE;
determining a priority of the uplink data, or an urgency of the uplink data, or both; and
in response to determining the priority of the uplink data, or the urgency of the uplink data, or both, delaying a wake-up of a main radio of the UE based at least in part on the priority of the uplink data in the buffer, or the urgency of the uplink data in the buffer, or both.

20. A base station, comprising:
at least one memory; and
at least one processor coupled with the at least one memory and configured to cause the base station to:
configure a threshold time to delay a wake up of a main radio of a user equipment (UE); and
receive a buffer status report (BSR), or a scheduling request (SR), or both based on the threshold time to delay the wake up of the main radio.
